(19) United States
(12) Patent Application Publication
(10) Pub. No.: US 2012/0188249 A1
(43) Pub. Date: Jul. 26, 2012

(54) DISTRIBUTED GRAPH SYSTEM AND METHOD

(75) Inventors: Donald Kretz, Plano, TX (US); Brian Griffey, Dallas, TX (US); Roderick Paulk, Wylie, TX (US)

(73) Assignee: Raytheon Company, Waltham, MA (US)

(21) Appl. No.: 13/014,515

(22) Filed: Jan. 26, 2011

(51) Int. Cl. G06T 11/20

(52) U.S. Cl. 345/440

(57) ABSTRACT

In certain embodiments, a system is provided that includes a graph distributed to form one or more partitions, a graph aggregate, and one or more graph services each associated with a graph partition. The graph services are in communication with the graph aggregate and the distributed graph is operable to be accessed using the graph aggregate.

### TECHNICAL FIELD

This disclosure relates generally to a distributed graph architecture and more particularly to a service oriented architecture for performing graph analysis.

### BACKGROUND

Using graph frameworks to organize large sets of information is an important tool for analyzing and exploiting the information. Various methods have been used to exploit information organized in graph frameworks, but these methods can require knowledge and manipulation of low-level data mechanics, which can be burdensome to program and resource intensive.

### SUMMARY

In certain embodiments, a system is provided that includes a graph distributed to form a plurality of partitions, each partition representing a portion of data from the graph; a plurality of graph services each associated with a respective one of the plurality of graph partitions, each graph service operable to provide functions for accessing the associated graph partition; and a graph aggregate in communication with the plurality of graph services and operable to provide functions to an application for analyzing the graph and utilize the functions of each graph service for accessing the associated graph partition. The graph aggregate is located on a computer and the computer is operable to receive the application through a client interface and host and execute the application. The application is operable to analyze graph data by calling functions provided by the graph aggregate, the graph aggregate further operable to call functions provided by the graph service based on function calls from the application. The system can also include a plurality of graph aggregates and the distributed graph can include a single global graph with an associated graph aggregate. The plurality of graph aggregates include subgraphs and at least one graph aggregate is operable to communicate with more than one subgraph. The application includes agents or KnowBots. The distributed graph appears as a single instance to the application. The system can also include a subgraph associated with the graph aggregate.

In other embodiments, a method is provided that includes distributing a graph into a plurality of partitions on a computer, each partition representing a portion of data from the graph; associating a plurality of graph services with a respective one of the plurality of graph partitions, each graph service operable to provide functions for accessing the associated graph partition; and associating a graph aggregate with the graph, the graph aggregate operable to provide functions to an application for creating a subgraph and to utilize the functions of the graph services for accessing the associated graph partition. The method can also include hosting the graph aggregate on a computer in communication with a client interface; receiving the application through the client interface; and hosting and executing the application on the computer. The graph services are further operable to provide functions for the graph aggregate to build the subgraph. The method can also include associating a single global graph aggregate to the distributed graph; and associating a plurality of graph aggregates to the distributed graph. The distributed graph can appear as a single instance to the application. The graph aggregate is further operable to perform pattern matching against the subgraph.

In other embodiments, an apparatus is provided that includes at least one computer-readable non-transitory storage medium comprising code, that, when executed by at least one processor, is operable to access a distributed graph using a graph aggregate by: receiving an application through a client interface; hosting and executing the application; creating a graph aggregate in response to the application, the graph aggregate in communication with the client interface and the application, the graph aggregate operable to create a subgraph; and creating graph services in response to the graph aggregate, the graph services associated with a partition of the distributed graph, the graph service in communication with the graph aggregate and operable to provide functions for accessing its associated graph partition. The graph aggregate is operable to receive function calls from the application and send function calls to one or more graph services based on the function calls from the application. The graph aggregate can include a global graph that includes a plurality of graph aggregates. The plurality of graph aggregates are operable to provide functions to one another. The graph aggregate is further operable to perform pattern matching against the subgraph. The graph services are further operable to provide functions for the graph aggregate to build the subgraph.

Certain embodiments of the present disclosure may provide one or more technical advantages. In certain embodiments, a graph framework is provided where the graph is distributed across multiple computers but accessed through a single graph aggregate using associated graph services. This enables an application or analyst to interface, analyze, and exploit a distributed graph without requiring knowledge or programming related to low-level data mechanics. In other embodiments, applications can be hosted within the graph framework, increasing the speed of analysis performed on the graph.

### BRIEF DESCRIPTION OF THE DRAWINGS

For a more complete understanding of the present disclosure and its advantages, reference is made to the following descriptions, taken in conjunction with the accompanying drawings, in which:

FIG. 1 illustrates a computer system architecture with a distributed graph framework according to some embodiments of the present disclosure.

FIG. 2 illustrates a logical data structure hierarchy that can be found within the distributed graph framework architecture of FIG. 1.

FIG. 3 illustrates a data structure and application hierarchy that can be found within the distributed graph framework architecture of FIG. 1.

### DESCRIPTION OF EXAMPLE EMBODIMENTS

It should be understood at the outset that, although example implementations of embodiments are illustrated below, various embodiments may be implemented using any number of techniques, whether currently known or not. The present disclosure should in no way be limited to the example implementations, drawings, and techniques illustrated below. Additionally, the drawings are not necessarily drawn to scale.

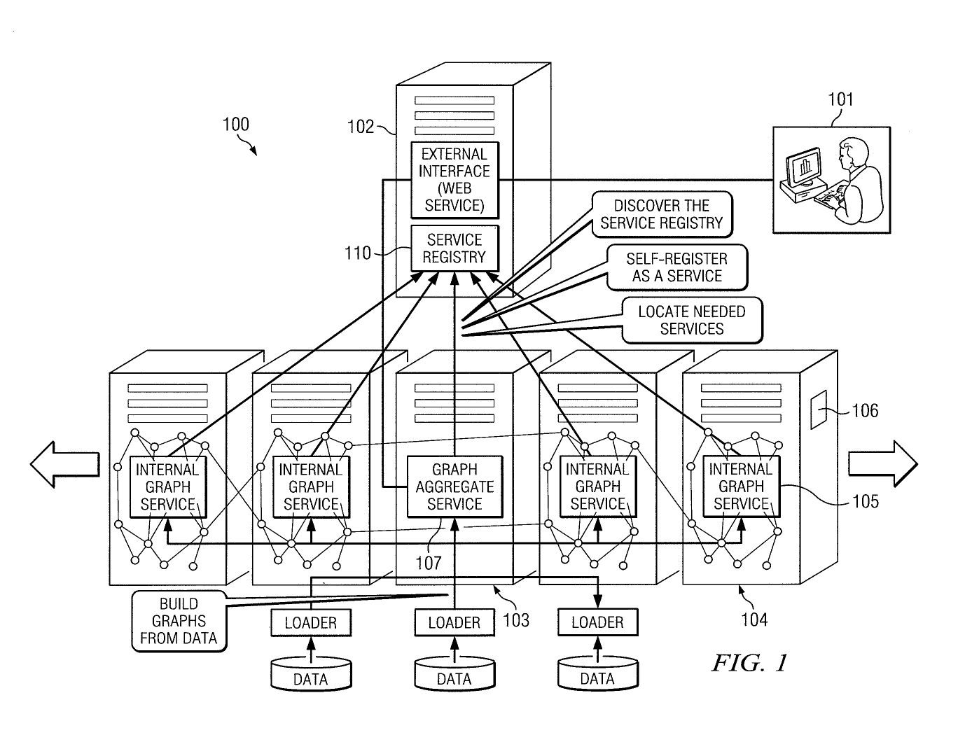

FIG. 1 illustrates a distributed graph framework 100 in accordance with some embodiments of the present disclosure. In some embodiments, distributed graph framework 100 can include an external interface or web service computer 102. Service computer 102 can serve as an interface for a user or application to a graph and can include a service registry 110. Service registry 110 can keep track of instantiations of graph services 105 and graph aggregates 107 as they are created across the graph framework 100. Each graph service 105 and graph aggregate 107 can find the registry 110 and register itself when it is created. The service computer 102 can have its own user interface, or an analyst can connect to computer 102 through his own workstation 101 through a web interface or browser. Interface computer 102 can be connected to a graph aggregate service computer 103. The connection can be any type of network or electrical connection known in the art. Aggregate computer 103 can host graph aggregates 107. The graph aggregates (“GA”) 107 can be implemented as a Java or C++ software object, for example. The graph aggregate computer 103 can be connected to several graph computers 104. The connection can also be any type of network or electrical connection known in the art. Each graph computer 104 can contain a graph partition 106 and graph services 105. Each graph partition 106 can reside in RAM and is part of a single graph that has been distributed across multiple computers 104. Fundamentally, a graph is an abstract representation of a set of objects where some pairs of the objects are connected by links. The interconnected objects are represented by vertices, and the links that connect some pairs of vertices are called edges. The distribution scheme can be a round-robin scheme or other graph distribution scheme known in the art. The objects in a graph can be any kind of data that has been linked together by any number of relationships to form a graph. Graph services 105 are contained in each computer 104 and each graph service 105 can be associated with the graph partition 106 hosted by computer 104. The graph service can be a Java or C++ software object, for example.

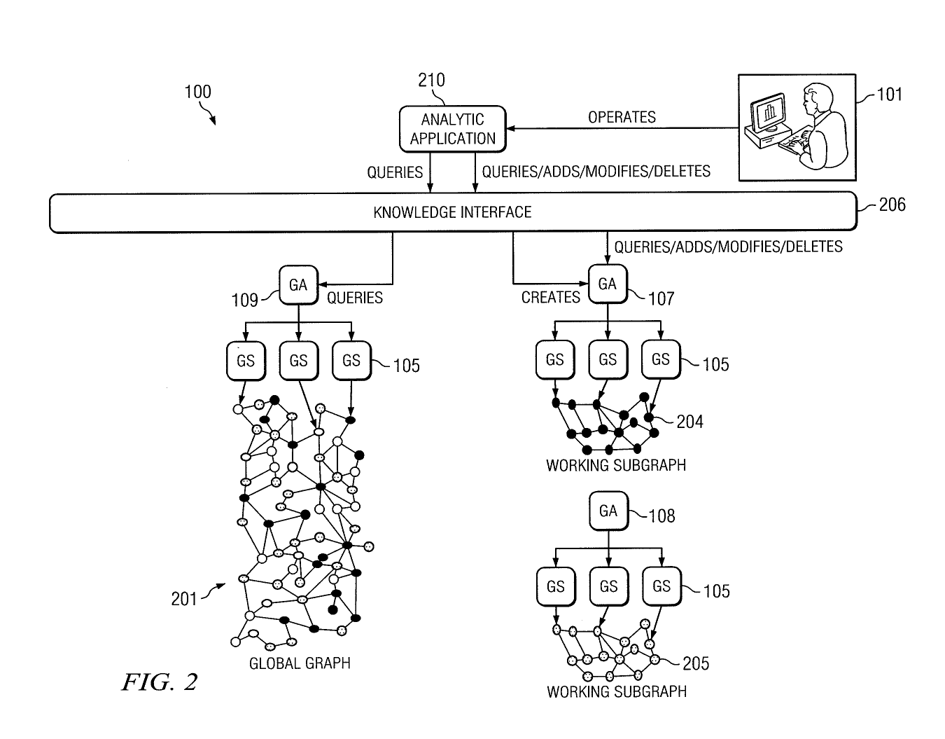

FIG. 2 illustrates a logical data structure hierarchy that can be found within the distributed graph framework architecture of FIG. 1. In reference to FIG. 2, in some embodiments of the present disclosure, applications 210 (or analyst 101) are in communication with a Global Graph (“GG”) 201, and access the global graph 201 through GA 107. GG 201 can be the entire knowledge base contents of the graph framework 100, including all graph partitions, working graphs, and subgraphs. GG 201 itself includes a graph aggregate 109 with associated graph services 105. In some embodiments, a user 101 interacts with the graph framework 100 by passing queries through analytic application 210 into an interface 206. Interface 206 sits between the analytic application 210 and the global graph 201. The queries cause the generation or instantiation of graph aggregates 107 and 108. These graph aggregates can include multiple functions or methods to create analysis exploitations of the global graph 201 by creating working graphs 204 and 205. As discussed, the GAs or graph aggregates 107, 108, and 109 can be software objects, such as java objects or C++ objects, with associated functions or methods. The GA methods that can be called or used by the applications to access the global graph 201 include such functions as: addRuleService, which will add pattern recognition rules to the graph under the GA; createSubgraph, which will create a new working graph from a subgraph of the graph under the GA that matches the given criteria. The new GA for this graph will be accessible by the given name; getName, which returns the name of the GA; getNodesNear, which returns all nodes within a distance of n of the given node; getNumberOfGraphs, which returns the number of working graphs created within the GA inclusive; saveGraph, which persists the graph to non-volatile storage; and unionGraph, which merges the underlying data structure. Additional graph functions known in the art can also be associated with the graph aggregates 107 and 108.

In reference to FIG. 2, the graph aggregates 107 and 108 can further instantiate graph services objects 105. The graph services objects 105 themselves include their own methods and function that can operate on and access the working graphs created by the graph aggregates 107 and 108. In some embodiments, the graph services objects are used to exploit and access the low level graph data or information of the global graph 201 in response to instructions or function calls from the graph aggregates 107 and 108. In some embodiments, each graph partition 106 has associated graph services 105 residing in the same host. Graph aggregates 107 and 108 may call a set of methods associated with the graph services objects 105 based on calls from applications or other graph aggregates within a working graph. These graph services 105 can include methods to access a graph partition 106 and manipulate working graphs associated with the graph aggregate, including: addEdges and addNodes, which add nodes or edges to the graph; getGraphStatistics, which return metrics on the graph, i.e. number of nodes, edges and free memory; nDegreeOf, which returns the number of incoming edges of the given node; getName, which returns the name of the graph service; getNodesByUUID, which returns the nodes associated with the given identifiers; getNodeSet, which returns all the nodes within the graph; getNodesThatMatch, which returns all the nodes that match the given criteria within the graph partition; getOutgoingEdgesOf, which returns all of the outgoing edges for the given node; removeEdge, removeEdges, removeNode and removeNodes, which removes the given nodes/edges from the graph; and saveGraph, updateNode, and updateNodes, which change information for the given node/edge. The applications 210 can communicate with the graph aggregates to use the methods on the graph aggregate/graph service interfaces, and the graph aggregates can communicate with the applications for patterns recognized with a rule service. In this manner, applications have a single point of access to multiple graph partitions. Additional graph functions known in the art can also be associated with the graph services 105.

The set of queries from the application 210 and the working graphs 204 and 205 created in response can be an analysis product for the analyst 101 to use in intelligence exploitation, for example. As discussed above, graph services 105 and graph aggregates 107 and 108 can register with service registry 110. Entries within the service registry can include such information as a description of the purpose of a graph aggregate and its subgraph and their location in the graph framework 100. Service registry 210 can be referenced and searched by application 210, the graph aggregates, or the graph services. In this manner, service registry 110 can be used to provide quick access to existing intelligence exploitations to new applications, other graph aggregates, or other graph services to assist in new or modified intelligence exploitations. For instance, multiple subgraphs can be found and joined through service registry 110 to satisfy new analyses.

In some embodiments, multiple GAs 107 and 108 can be instantiated within graph framework 100. These additional graph aggregates can each have associated subgraphs or working graphs (domain base), illustrated as 204 and 205. Each of these working graphs 204 and 205 has the ability to create more subgraphs (working graphs) via their GA 107 and 108. This can create a hierarchical access structure where an analyst or application limits their task within a working graph 204 or 205 of the global graph 201 that is the area of focus and only accesses the working graphs through the graph aggregates. In some embodiments, the GA 107 and 108 for this focused area cannot see out of the focus area. Additional GAs and can be created to create/access working graphs for as many focus areas that are desired, and additional working graphs can be created from these focus areas (not shown). GAs can be created for working graphs that have an intersection with other working graphs (not shown). In these cases, updates within the intersection can be visible to all vested GAs. In addition, each working graph can be in communication with graph services 105, which can operate on and analyze associated graph partitions 106, as discussed below.

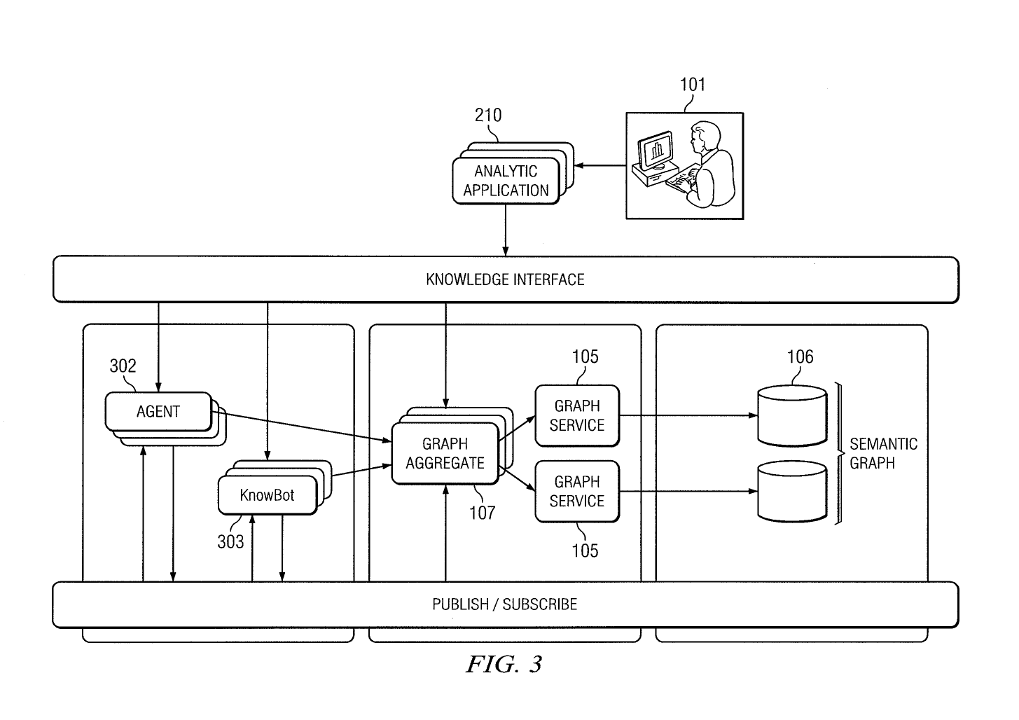

FIG. 3 illustrates a data structure and application hierarchy that can be found within the distributed graph framework architecture of FIG. 1. At the top, an analyst 101 is shown interfacing with the graph framework using her local workstation. The analyst 101 can interface with the graph framework through a web service or client application on her workstation and through the use of an analytic application 210 that the analyst may pass into the graph framework through the web service or client application. The analytic application 210 can contain queries or other types of analysis algorithms or routines that an analyst or application wishes to run on the data contained in the graph framework. Below the analytic application 201, agents 302 and KnowBots 303 are shown. As with the analytic application 301, agents 302 and KnowBots 303 (Knowledge-Based Object Technology) can be computer-based objects developed for collecting and storing specific information, in order to use that information to accomplish a specific task, and to enable sharing that information with other objects or processes. Examples of agents and KnowBots include Risk Assessment, Space Protection, Tactical Fusion, Botnet Detection, Infrastructure Protection, Nuclear Proliferation, Narco Terrorism, or Maritime Security. These agents 302 and KnowBots 303 can reside within the graph framework and can continuously collect and share information gathered from the framework. They could equally be crop development, susceptibility to forest fire, crowd appearance, heat loss from structures, tracking fugitives or lost persons, geographic features, mineral deposits, current circulation, contaminant dispersal or like attributes subject to presentation in graphical frames. Moreover, analytic application 301 can be passed through the web or client application interface by the analyst 101 and hosted and executed within the graph framework in the same way as agents 301 and KnowBots 303. In some embodiments, analytic application 301, and agents 302 and KnowBots 303 can be hosted and executed in the same computer that hosts and executes graph aggregates 107. As discussed in referenced to FIG. 2, analytic applications 301, agents 302, and KnowBots 303, access the global graph 201 through the creation of one or more graph aggregates, each including graph services and subgraphs.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A system comprising:
a graph distributed to form a plurality of partitions, each partition representing a portion of data from the graph;
a plurality of graph services each associated with a respective one of the plurality of graph partitions, each graph service operable to provide functions for accessing the associated graph partition; and
a graph aggregate in communication with the plurality of graph services and operable to provide functions to an application for analyzing the graph and utilize the functions of each graph service for accessing the associated graph partition.

2. The system of claim 1 wherein the graph aggregate is located on a computer and the computer is operable to receive the application through a client interface and host and execute the application.

3. The system of claim 2 wherein the application is operable to analyze graph data by calling functions provided by the graph aggregate, the graph aggregate further operable to call functions provided by the graph service based on function calls from the application.

4. The system of claim 1 further comprising a plurality of graph aggregates and wherein the distributed graph comprises a single global graph with an associated graph aggregate.

5. The system of claim 4 wherein the plurality of graph aggregates comprise subgraphs and wherein at least one graph aggregate is operable to communicate with more than one subgraph.

6. The system of claim 1 wherein the application comprises agents or KnowBots.

7. The system of claim 1 wherein the distributed graph appears as a single instance to the application.

8. The system of claim 1 further comprising a subgraph associated with the graph aggregate.

9. A method, comprising:
distributing a graph into a plurality of partitions on a computer, each partition representing a portion of data from the graph;
associating a plurality of graph services with a respective one of the plurality of graph partitions, each graph service operable to provide functions for accessing the associated graph partition; and
associating a graph aggregate with the graph, the graph aggregate operable to provide functions to an application for creating a subgraph and to utilize the functions of the graph services for accessing the associated graph partition.

10. The method of claim 9 further comprising:
hosting the graph aggregate on a computer in communication with a client interface;
receiving the application through the client interface; and
hosting and executing the application on the computer.

11. The method of claim 10 wherein the graph services are further operable to provide functions for the graph aggregate to build the subgraph.

12. The method of claim 9 further comprising:
associating a single global graph aggregate to the distributed graph; and
associating a plurality of graph aggregates to the distributed graph.

13. The method of claim 9 further comprising:
the distributed graph appearing as a single instance to the application.

14. The method of claim 1 wherein the graph aggregate is further operable to perform pattern matching against the subgraph.

15. An apparatus comprising:
at least one computer-readable non-transitory storage medium comprising code, that, when executed by at least one processor, is operable to access a distributed graph using a graph aggregate by:
receiving an application through a client interface;
hosting and executing the application;
creating a graph aggregate in response to the application, the graph aggregate in communication with the client interface and the application, the graph aggregate operable to create a subgraph; and
creating graph services in response to the graph aggregate, the graph services associated with a partition of the distributed graph, the graph service in communication with the graph aggregate and operable to provide functions for accessing its associated graph partition.

16. The apparatus of claim 15 wherein the graph aggregate is operable to receive function calls from the application and send function calls to one or more graph services based on the function calls from the application.

17. The apparatus of claim 15 wherein the graph aggregate comprises a global graph comprising a plurality of graph aggregates.

18. The apparatus of claim 17 wherein the plurality of graph aggregates are operable to provide functions to one another.

19. The apparatus of claim 19 wherein the graph aggregate is further operable to perform pattern matching against the subgraph.

20. The apparatus of claim 19 wherein the graph services are further operable to provide functions for the graph aggregate to build the subgraph.
